(19) United States
(12) Patent Application Publication
(10) Pub. No.: US 2002/0178094 A1
(43) Pub. Date: Nov. 28, 2002

(54) Publication, exchange and update system of information about debts

(76) Inventor: Maciej Kaczmarski, Wroclaw (PL)

Correspondence Address: MACIEJ KACZMARSKI, LIONSKA 6, WROCLAW, 51-215, PL

(21) Appl. No.: 09/862,394

(22) Filed: May 23, 2001

(51) Int. Cl. G06F 17/60

(52) U.S. Cl. 705/30

(57) ABSTRACT

This application pertains to described above procedures of maintenance of the data base about debts. New idea is the system of publication, exchange and updating data about debts by creditors, data commonly accessible on web site for everyone interested in, system maintenance by independent manager with described procedures of its maintenance.

### BACKGROUND OF THE INVENTION

Subject of this application is the system, which may become a new tool for a business. The system of the nature is a computerized tool, but some procedures have to be done by the system manager only.

### BRIEF SUMMARY OF THE INVENTION

The application pertains to a system, which allows the system manager to organize the exchange of the trustful information about unpaid debts in the business. The system is to be made up of the database and procedures of its maintenance.

The system is to be commonly accessible on the web site. The system manager does every action, which can not be done by computers, like e.g. a mailing citation of the payment due to the debtor.

Here are the merits of the system:

1. A common access to information about unpaid debts—this information are commonly accessible in the web site, for everyone to be interested in,

2. A creditor is anonymous—among commonly accessible information there are no creditor data,

3. A possibility of anonymous contact between the creditor and any one to be interested in any particular debt,

4. The protection of the debtor rights—before a publication debtors are informed about this facts, and there is time to pay, or to register a protest into the system,

5. A credibility of an information—creditors are obliged to update all information,

6. An independent position of the system manager, who is only organizing the exchange of information.

All responsibilities for adding either untrue or erasing paid debts are to be bore by the creditor.

### DETAILED DESCRIPTION

1. Glossary.

Database—the commonly accessible database made up files added by creditors in an add procedure.

Publication—to let database files commonly accessible.

Common accessibility—access for everyone to be interested in already published data about a debtor and a debt. The common accessibility does not mean that an access has to be free of charge. The manager may add a billing system to charge fees for use of all or only for chosen procedures. A common accessibility is realized by an access to the data on the web site.

A creditor—the creditor term should be interpreted without any problems.

A user—every one using the system database in another way than the debtor, the creditor or the manager.

A debtor—every one claimed as being owe to the creditor, what does not mean that creditor is every time right.

A manager—is one, who manages and makes the system accessible to the users, the creditors and the debtors. The manager is independent of users, creditors and debtors.

It is possible to be at the same time user, debtor and creditor and use system in the way characteristic for every of this person. Purpose of this division is to make this description clear.

2. System Options.

System makes enable:

the user to:

1. search in the data base for information, e.g. to check status of indebted one,

2. create a group of business partners for monitoring procedure, e.g. to supervise their financial condition,

3. lead up anonymous correspondence with creditor, e.g. to buy debt at lower price;

the creditor to:

1. send by the system the citation of payment due to any debtor, with warning of publication if debt will not be paid,

2. receive by the system debtors protests, when any debtor considers that creditor is wrong, e.g. when creditor wants to publish data about non existing debt,

3. exchange of anonymous information between any creditor and every one interested in particular debt matter, e.g. to sell debt to user,

4. edit the database, e.g. to erase data or to reduce amount of debt, when only a part of debt was already paid;

the debtor, who received citation of payment due, to carry out correspondence with the creditor before publication, e.g. to fix longer term to pay debt;

the manager to organize the exchange of information, to charge fees. The manager takes care of keeping in secret all the information not allowed for public use, like e.g. the name of creditor.

3. Description of Procedures.

System is realizing its function of the data exchange between the creditors, the debtors and the users throughout described procedures.

3.1. System Entrance

There is main menu to enter to the system. There are four enter fields. The debtor entrance directs to protest procedure. The creditor entrance—after login directs to the mailing of citation of payment due procedure. The user entrance—directs to the search procedure or the monitoring procedure according to users choice. The new user registration entrance—directs to the new user registration procedure.

3.2. New User Registration Procedure.

This procedure is to be carried out only once for anybody who wants to use the creditor entrance. One, who wants to use the creditors entrance must fill in an application form prepared by manager and enclose specified documents. After this procedure, the creditor will be identified in the system by creditors password. The password is given by the system manager. The creditors are told that they are fully responsible for publication and update of all data, they added to the system database. The creditors data are only available for the authorities, especially the judiciary.

3.3. Citation of Payment Due Procedure.

This operation is available for creditors only. The creditor must login into the system using his or her password. The creditor has possibility to send to the debtor the citation of payment due using the system. The citation of payment due is a letter and there is information about possible publication, if debtor will not pay in time. To send the citation of payment due the creditor must fill in an application form. This are the information, that are to be filled in: debtors name; a title of the debt, e.g. a loan, a bill of exchange, etc.; a debt amount; a price of debt, if creditor wants to sell it. After filling in the application form, the creditor is sending it to the system. The manager mails the letter citation of payment due to the debtor by post. This letter contains: creditors name; a title of debt; a debt amount; an information that it is possible to publish debtors data in the commonly accessible data base; an information, what the debtor can do to avoid publication, and how can the creditor react; an unique debt number, which is a key to identify this debt in the system. This number allows debtor to use debtors entrance and use protest procedure. After the creditor sends the citation of payment due form to the system the debtor has time to pay debt, e.g. 21 days, or to use the protest procedure. The creditor is informed, that the operation citation of payment due has begun and comes back to main menu.

3.4. Protest Procedure.

Purpose of this operation is to protect debtor rights, against publication. To use this procedure debtor has to chose from main menu debtors entrance and login with number from the citation of payment due letter. If the number has been typed wrong, the system will came back to the main menu, otherwise the debtor can choose one of two protests: ‘I have paid’, ‘I disagree’. Choosing ‘I have paid’ protest the debtor has to fill in an application form. There are two fields in this application form. First is when debt has been paid, second in which form, e.g. a money order, in cash etc. After filling in this protest it is not possible to send ‘I disagree’ protest.

‘I disagree’ protest allows debtor to use the system to send answer to the creditor. The debtor fills in a text field, and sends it by the system to the creditor. After this protest has been sent, there is no possibility for the debtor to use ‘I have paid protest’. The debtor can add his or her e-mail address to receive answer from the system, how did the creditor react, e.g. what new publication term fixed creditor. After any protest has been sent the debtor comes back to main menu.

The creditor can receive from the debtor an answer by the system. Now creditor can: publish information about debt and debtor, than the system goes to the publication procedure; give up publication—system goes back to the main menu; fix another, longer term for payment, and another longer term for publication if debt will not be paid. If the debtor sent to the creditor a protest and the creditor did not made any decision, system will not go to the publication procedure, even if the term of publication expired.

3.5. Publication Procedure.

This procedure is to be done by the manager. It depends on the creditor only if he or she will erase or edit debtor data. Following data are published: debtors name; a title of obligation; a debt amount; a price of debt, if creditor wants to sell it only; an information if there was debtors protest ‘I disagree’. There will be no creditors data published. Access to the published data is possible throughout the search procedure or the monitoring procedure. Published information will be accessible through a period of time. The manager specifies how long, e.g. one year. After this time the manager will ask if the creditor wants data to be published for another period of time or not. The creditor can always (before or after) publication erase debtors data, e.g. if the debtor paid.

3.6. Search Procedure.

This operation is for the system users and allows them to search for published data in the system database. User must type a full name of searched one. There two types of answer possible. First one is ‘no data’. The second answer will consist following data: full name of searched one; an amount of all debts published; an information of ever single debt—its amount; a title of obligation, e.g. a bill, a loan, etc.; an information of debt price, if the creditor wants to sell it; an information if there were debtors protest ‘I disagree’ or not. Now user can came back to the main menu or go to the anonymous information exchange procedure.

3.7. Anonymous Information Exchange Procedure.

This procedure is for the creditor and the user, but only the user can start it. Exchange can be done to published debts, and only to those where the creditor fixed sell price. To use this procedure the user has to give to the manager his or her e-mail adres. This procedure allows anonymous exchange of the information, about single debt. The manager passes on all information between the creditor and the user. Both the creditor and the user did not know each other. Only if any one of them during the exchange of information will disclose data, then they will be able to contact without help of the system. Information exchange is in form of e-mail exchange, but there is the manager between the creditor and the user.

3.8. Monitoring Procedure.

To use this procedure the user must give his or her e-mail adres to the manager. The user especially interested in information about a group of business partners can prepare a list of them and the manager will be sending to the user automatically all information. Like in search procedure the user will have access to commonly accessible information only. The manager will update information in specified time period, e.g. every day. All information will be sent on the users e-mail adres.

Choosing the monitoring procedure the user can create, add or erase a list of names, he wants get information about in this way.

3.9. Edition Procedure.

This procedure is for the creditor. It allows the creditor to edit or erase data before or after publication. The edition can be done with all debts data with only one exception, which is, that amount of debt can only be decreased. Choosing this procedure creditor will see a list of debts added by him or her and can choose those, which he or she wants to correct or erase.

3.10. Manager Edition Procedure.

The manager has possibility to change data in the database but only on command of the authority, especially the judiciary.

4. The Embodiment of the System

The system should find its embodiment in form of the computer program, which will operate database compatible to described procedures. Some operations have to be done out of the computer program, like e.g. mailing of the citation of payment due. There are number of computers and operating systems, so the subject of this application is the useful process of data exchange arranged for the matter of debts, process specified by the described procedures, which procedures can easily be convert into the computer program.

5. How to Make a Use of System?

The system is invented for wide range of users and there is no need to have knowledge in the computer science to use system. To work with the system there is only need to choose appropriate procedure and to fill application forms in.

1. What I claim as my invention is the system of publication, exchange and update of information about debts, system being made up of the database and the procedures of its maintenance, system which is considered to serve useful process for the subject matter to which system pertains.
